(19) United States
(12) Patent Application Publication
(10) Pub. No.: US 2006/0114593 A1
(43) Pub. Date: Jun. 1, 2006

(54) Level detector

(76) Inventor: Xavier Sagaert, Deerlijk (BE)

Correspondence Address: James C. Wray, Suite 300, 1493 Chain Bridge Road, McLean, VA, 22101, US

(21) Appl. No.: 11/269,510

(22) Filed: Nov. 8, 2005

(30) Foreign Application Priority Data
Nov. 8, 2004 (BE) 2004/0543

(51) Int. Cl. G11B 15/18

(52) U.S. Cl. 360/72.2

(57) ABSTRACT

The present invention concerns a level detector (1) for a domestic or industrial water softener in which the said detector (1) comprises a sensor (2) which is equipped to detect the salt level in the brine tank (3) of the water softener. As a result, the salt level is watched at all times so that it is impossible that the brine tank falls empty and that the appliances connected to the water supply system are damaged due to limescale deposits. The sensor used preferably is an ultrasonic sensor that is placed at the top of the water softener and that is equipped to detect within a detection area (4).

This application claims the benefit of Belgian Application No. 2004/0543 filed Nov. 8, 2005, which is hereby incorporated by reference in its entirety.

### BACKGROUND OF THE INVENTION

The present invention concerns on the one hand a level detector comprising a sensor that is equipped to detect the salt level in the brine tank of a water softener. On the other hand, the present invention concerns a water softener equipped with such a level detector.

Hard water has a high lime content. Limescale deposits (CaCO₃) consist of several elements, to wit calcium and magnesium. In too large concentrations, these elements may cause nuisance problems for a number of domestic and industrial installations. In water-conducting appliances, they lead to scale build-up on pipes, faucets, etc.

In order to reduce the quantity of lime in the water, a water softener is often connected to the water supply. The best known water softeners, also called water decalcifiers or water descalers, comprise a conditioning tank, in which the water is softened, especially by removing the calcium (Ca2+) and magnesium (Mg2+) ions from the water through the help of an ion exchange resin. Such resin exchanges calcium and magnesium ions in the water with sodium ions. The softeners are further equipped with a brine tank in which the regeneration process takes place. During that process, the resin will, with the help of a brine solution, regain sodium ions and give off the calcium and magnesium ions, that in turn disappear in the drainpipe.

In order to guarantee a smooth functioning of such water softener, the salt content in the brine tank, mostly supplied in tablet form, has to be kept up at all times, preferably half-full.

However, it appeared that many users of a water softener forget to keep the salt content at level as a result of which the water softening process comes to a stop, damaging for instance water heating appliances, faucets, pipes, etc.

There already are known appliances that draw the attention of the users of domestic or industrial water softeners to the fact that the brine tank has reached its lowest level and that it has to be topped up urgently.

The American patent publication US 2002/0149489 A1 describes an automatic level detector that warns the users when the salt level in a water softening tank is too low. To that end, the level detector concerned comprises a transmitter and a series of receivers. The receivers are photoelectric cells that are arranged at a regular distance from one another in a synthetic tube. This tube is placed in the tank with the salt. Depending on the fact whether or not the photoelectric cells are illuminated by a ray of light coming from the transmitter, the detector determines the salt level. When the salt level reaches a minimum level, the detector will generate a warning signal and thus warn the user.

This system has the disadvantage that, after some time, it does not give good results anymore, as:
the photoelectric cells become scratched when the tank is topped up with salt;
a salt layer is deposited on the synthetic tube.
   Due to these reasons, the photoelectric cells are no longer illuminated (no more detection) as a result of which a correct level detection is no longer possible.

In addition, the level detector described in US 2002/0149489 is not universally applicable as the height of the synthetic tube depends on the height of the water softening tank. Thereby, a corresponding synthetic tube has to be provided for in another type of water softener. Furthermore, this detector cannot be installed on existing water softeners.

### SUMMARY OF THE INVENTION

The object of the present invention is to construct an appliance that is universally applicable and that can be installed both on new and on existing water softeners.

The object of the invention is achieved by providing a level detector comprising a sensor that is equipped to detect the salt level in the brine tank of a water softener, in which the aforementioned sensor is an ultrasonic sensor that is equipped to detect within a detection area.

As a result, the salt level is watched at all times so that it is impossible that the brine tank falls empty and that limescale deposits cause damage to the appliances connected to the water supply system.

The level detector according to the invention is universally applicable as the said detector does not have to be adjusted depending on the type and the height of the water softener. Furthermore, the level detector according to the invention can also be installed on existing installations.

In a more preferential version of the invention, the level detector is equipped with adjusting means to set the range of the sensor within the detection area. As a result, it is possible to set the range of the sensor depending on the type and the height of the water softener.

In a preferential version, the level detector according to the invention allows to detect the variation of the height difference of the salt level per millimeter.

In a more preferential version of the level detector according to the invention, the detection area is delimited by a minimum and a maximum limit, in which the detection area is comprised within a minimum limit of 30 and a maximum limit of 1200 mm.

In a more particular version, the detection area is situated between a minimum limit of 110 and a maximum limit of 950 mm. More particularly, the detection area is comprised between a minimum limit of 300 and a maximum limit of 700 mm.

Preferably, the said level detector is equipped to generate a signal when the salt level exceeds a minimum level that was previously set by the user.

As it is possible to set the minimum level of the detector oneself through the adjusting means, one so to speak obtains a universal detector, that can be placed on several versions (different heights of brine tanks) of water softeners.

In a preferential version, the generated signal is a sound and/or visual signal. An example of a sound signal for instance is a buzzer. Visually, the user can be warned for example by a led on a casing (electricity box).

When the users hear and/or see the signal they know that salt has to be topped up. The signal will only stop when the salt level again rises above the minimum level set by the user. When the water softener equipped with a detector according to the invention is installed in a noisy environment or on a place that is difficult to reach, it can happen that the sound and/or visual signal is not seen or heard. For this reason the detector according to the invention can in a preferential version be equipped with a GSM-module, so that when the detector raises the alarm, a signal, e.g. an SMS, fax or e-mail, is sent to the maintenance technician.

In a more particular version of the level detector according to the invention, the said detector comprises a casing with plug, in which the plug is equipped to connect the detector to the electricity grid.

Another subject of the present patent application concerns a water softener in which the said water softener comprises a sensor which is equipped to detect the salt level in the brine tank of the water softener. Preferably, the water softener comprises a level detector according to one of the conclusions 1 to 7.

Water softeners equipped with a level detector according to the invention have the advantage that they warn the user if the salt level is too low.

To further explain the characteristics of the present invention and to indicate additional advantages and particularities thereof, a more detailed description of a level detector according to the invention follows below. May it be clear that nothing in the following description can be interpreted as a limitation of the protection for the present invention claimed in the conclusions.

In the present description, reference is made to the enclosed drawings by means of reference numbers, in which:

### BRIEF DESCRIPTION OF THE DRAWINGS

FIGS. 1 and 4 is a representation of a level detector according to the invention;

FIG. 2 is a representation of a brine tank of a water softener in which the salt level has sunk below the set minimum level;

FIG. 3 is a representation of a brine tank of a water softener in which the salt level is situated above the set minimum level;

FIG. 5 is a side view of the level detector according the invention;

FIG. 6 is a representation of a brine tank of a water softener provided with a level detector radiating ultrasonic rays.

### DETAILED DESCRIPTION OF THE PREFERRED EMBODIMENTS

Industrial or domestic water softeners comprises on the one hand a conditioning tank (not represented on the figures) equipped with an ion exchange resin, in which the calcium and magnesium ions are extracted from the water, and on the other hand a brine tank (3) for the regeneration of the said resin.

In order to guarantee a good functioning of the water softener, the salt level has to be kept up, as the regeneration process cannot take place when there is no more salt (7) and the softener does not function properly, resulting in damage to water heating appliances, faucets, pipes, etc. For that reason, the brine tank (3) of a water softener is equipped with a level detector (1) that draws the user's attention to the fact that the brine tank (3) has reached the minimum level (M) and that is has to be topped up urgently.

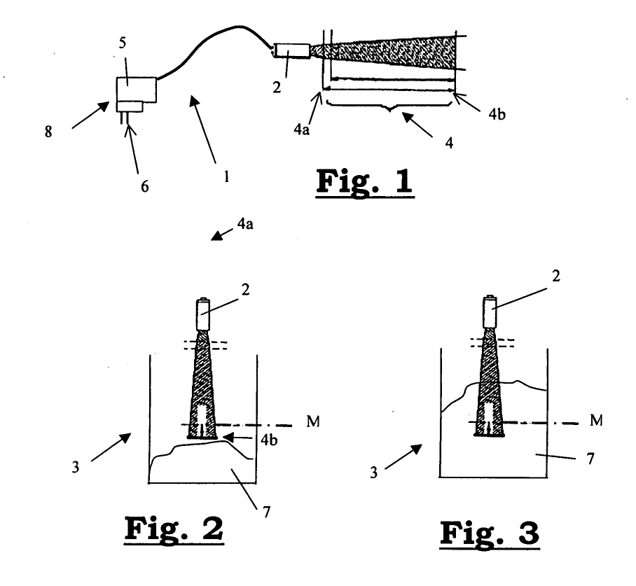

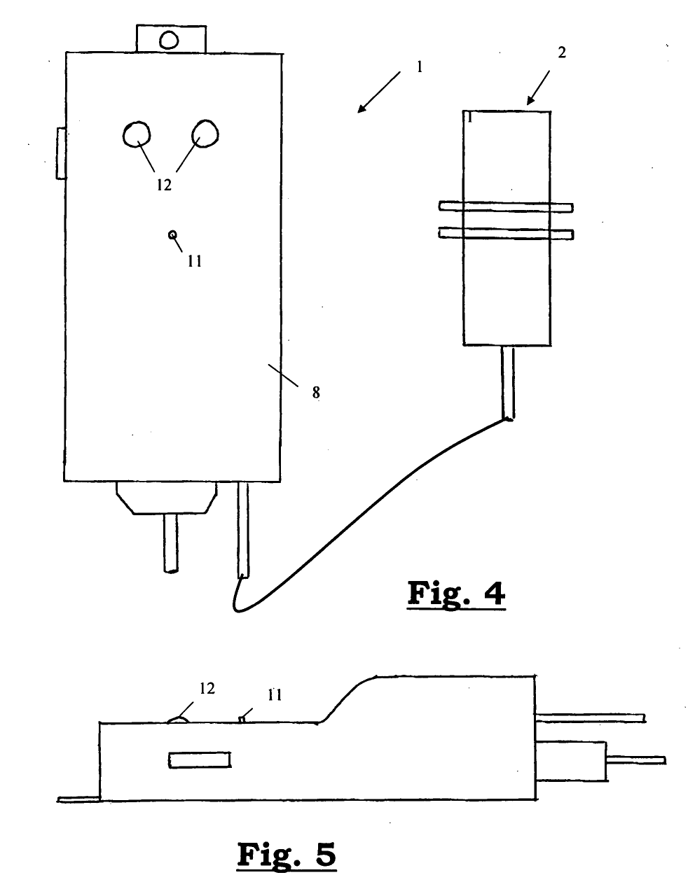

The level detector (1) according to the invention, and as represented in FIGS. 1 and 4, is composed of an ultrasonic sensor (2) equipped to detect the salt level in the brine tank (3) of the said water softener. The sensor (2) is equipped to detect within a certain detection area (4), in which the detection area (4) is situated between a minimum limit (4a), preferably 30 mm, and a maximum limit (4b), preferably 1200 mm.

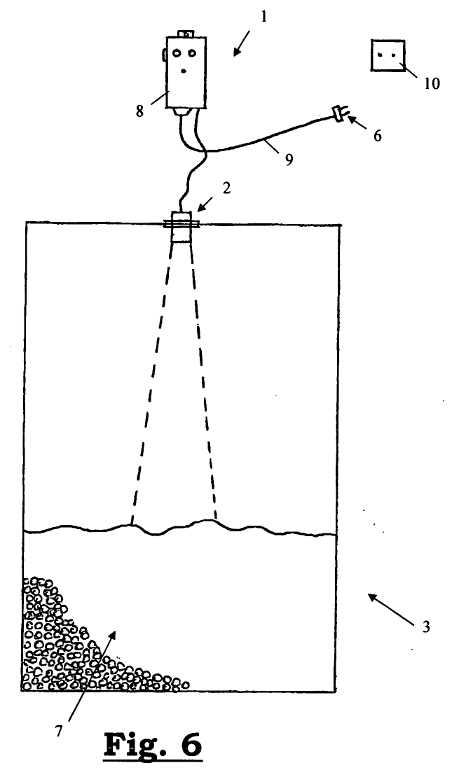

Furthermore, the level detector (1) comprises a casing (8) with plug (6), equipped to connect the detector (1) to the electricity grid via for example a socket (10). The casing (8) is furthermore equipped with adjusting means (5), for example a push button (11), to set the minimum level of the sensor (2) within the detection area (4). As represented in FIG. 6, it is also possible to provide the casing (8) with a disconnectable wire (9) with plug (6) to a the socket (10).

The sensor (2) is placed at the top of the brine tank (3) of the water softener and connected to the electricity grid. At first use, the range of the sensor (2) is set, in other words, the user will set the minimum level(M) of the sensor (2).

When the salt level, as represented in FIG. 3, is situated above the minimum level (M) and does not exceed the minimum limit (4a), the detector (1) will not react.

The level detector will only generate a sound signal, e.g. through a buzzer in the casing (8), and/or a visual signal, e.g. through a led (12) on the sensor (2) or on the casing (8) (electricity box), when the salt level is situated either above the minimum limit (4a), or under the preset minimum level (M), as represented in FIG. 2. The signal will only end when salt is topped up and the salt level raises above the minimum level (M). In water softeners equipped with a level detector (1) according to the invention, the salt level (7) is watched at all times, so that it becomes impossible that the brine tank (3) falls empty and that therefore it is excluded that limescale deposits cause damage to the appliances connected to the water supply system.

1. Level detector (1) comprising a sensor (2) equipped to detect the salt level in the brine tank (3) of a water softener with the characteristic that the said sensor (2) is an ultrasonic sensor that is equipped to detect within a detection area (4).

2. Level detector (1) according to claim 1, with the characteristic that the said level detector (1) is equipped with adjusting means (5) to set the range of the sensor (2) within the detection area (4).

3. Level detector (1) according to claim 1, with the characteristic that the detection area (4) is delimited by a minimum (4a) and a maximum (4b) limit, in which the detection area (4) is situated between a minimum limit of 30 and a maximum limit of 1200 mm.

4. Level detector according to claim 1, with the characteristic that the detection area (4) is situated between a minimum limit of 110 and a maximum limit of 950 mm.

5. Level detector (1) according to claim 1, with the characteristic that the said level detector (1) is equipped to generate a signal when the salt level exceeds a preset minimum level (M).

6. Level detector (1) according to claim 5, with the characteristic that the said signal is a sound and/or visual signal.

7. Level detector (1) according to claim 1, with the characteristic that the level detector (1) comprises a casing (8) with plug (6), in which the plug is equipped to connect the detector (1) to the electricity grid.

8. Water softener with the characteristic that it comprises an ultrasonic sensor (2) which is equipped to detect the salt level in the brine tank of the said water softener.

9. Water softener according to claim 8, with the characteristic that the said water softener comprises a level detector (1) according to one of the conclusions 1 to 7.
